(19) United States
(12) Patent Application Publication
(10) Pub. No.: US 2013/0097229 A1
(43) Pub. Date: Apr. 18, 2013

(54) SYSTEM AND METHOD FOR PROVIDING SERVICES TO DEVICES VIA A COMMON INTERFACE

(71) Applicant: BERG LIMITED, London (GB)

(72) Inventors: Matthew William Webb, London (GB); Jack Schulze, London (GB); Nicholas Tristan Ludlam, London (GB)

(73) Assignee: BERG LIMITED, London (GB)

(21) Appl. No.: 13/653,973

(22) Filed: Oct. 17, 2012

Related U.S. Application Data
(60) Provisional application No. 61/548,648, filed on Oct. 18, 2011.

(51) Int. Cl. G06F 15/16

(52) U.S. Cl. 709/203

(57) ABSTRACT

Embodiments are directed to using a cloud-based control center to provide services to wireless remote client devices through a common interface. The wireless remote client devices communicate with a bridge over a wireless link. The bridge communicates with the control center via a wired or wireless link via an interface that is common to all bridges. The bridge is configured with applications that operate in a “cloud” configuration that provide the data to each of one or more the wireless remote client devices as is necessary for the wireless remote client to perform the functionality assigned to it. In an embodiment, a client is a smart object, such as a printer, a clock, or a radio that receives data and instructions from a control center. The control center obtains the data from other sources and provides to the client via the bridge.

### CROSS REFERENCE TO RELATED APPLICATIONS

This application claims the benefit of Provisional Application No. 61/548,648 filed Oct. 18, 2011. The 61/548,648 application is incorporated by reference herein, in its entirety, for all purposes.

### BACKGROUND

Increasingly, data are being distributed through wireless networks to wireless devices connected to a common gateway device. For example, Wi-Fi networks based on IEEE 802.11x standards are found in the home, business and public facilities.

The services offered by these wireless networks typically rely on applications located in an endpoint device, such as a computer or smart phone. The applications provide the endpoint device instructions that allow the device to provide multiple services. The endpoint device must be technologically robust to perform all of the functions of all of the applications loaded on to it. The technological dexterity of such a device, particularly when unused functionality is considered, is reflected in the high costs of acquisition and maintenance.

The services also tend to originate from multiple sources. Thus, the endpoint device must interact with the different sources through a variety of interfaces.

### SUMMARY

Embodiments are directed to using a cloud-based control center to provide services to wireless remote client devices through a common interface. The wireless remote client devices communicate with a hub (also referred to herein as a “bridge”) over a wireless link. The hub/bridge communicates with the control center via a wired or wireless link via an interface that is common to all hub/bridges. The hub/bridge is configured with applications that operate in a “cloud” configuration that provide payloads to each of one or more of the wireless remote client devices as is necessary for the wireless remote client to perform the functionality assigned to it. As used herein a “payload” may include both content and commands.

In an embodiment, a client is a smart object, such as a printer, a clock, or a radio that receives data and instructions from a control center. The control center obtains the data from other sources and provides it to the client via the hub/bridge.

In an embodiment, the system can provide encouragement to a user to utilize certain applications that have an impact on the various smart objects. For example, if the user subscribes to a particular service but has not used that service in a certain period of time, the control center can obtain data from the particular service and send a message to the user with a graphic indicator noting that the service has not been used over a period of time. This will have the effect of reminding the user of the particular service and possibly spurring the user to engage that particular service on a more frequent basis.

The iconic representations can take any form including facial forms (happy face, sad face, neutral face), symbols such as exclamation points, stars or other symbols representing various states. These above graphical or iconic representations are not meant as limitations. Those skilled in the art will understand that various types of graphics, including colors, can be used as indicators relating to the use, or lack thereof, of particular applications available to a user.

### DESCRIPTION OF THE DRAWINGS

FIG. 1 is a block diagram illustrating a system architecture according to an embodiment.

FIG. 2 is a flow diagram illustration an authentication process according to an embodiment

FIG. 3 is a block diagram illustrating components of a client device.

FIG. 4 is a block diagram illustrating a server device.

### DETAILED DESCRIPTION

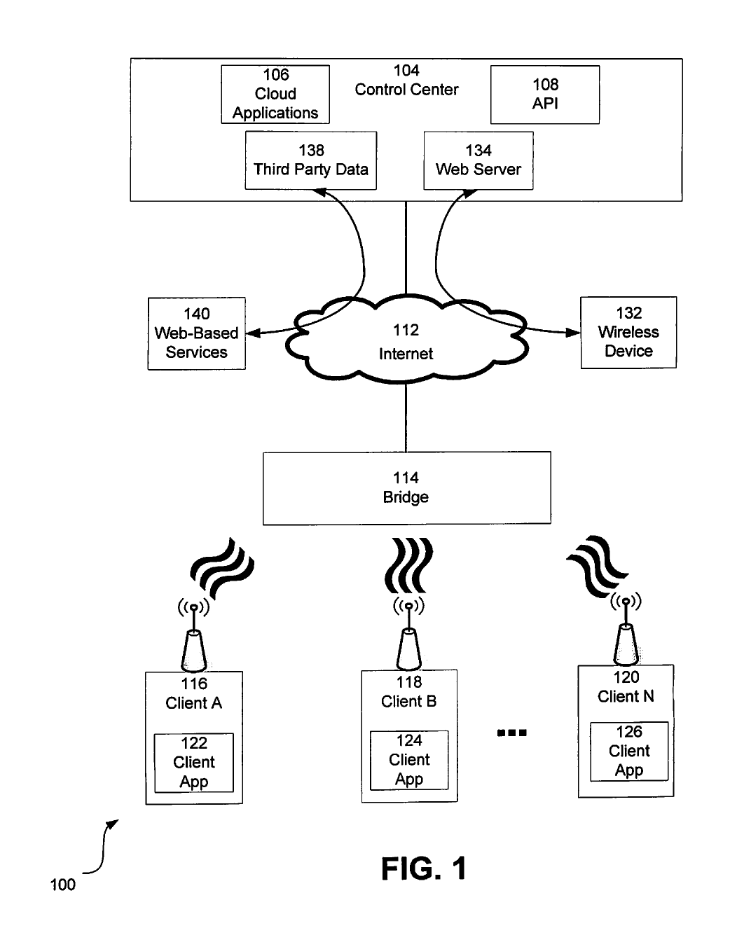

FIG. 1 is a block diagram illustrating a system architecture according to an embodiment.

A system 100 comprises a control center 104, a hub/bridge 114, one or more client devices A, B . . . N (elements 116, 118 and 120 of FIG. 1) that are served by the hub/bridge 114, and a web server 134. The client A 116 includes a client application 122. The client B 118 includes a client application 124. The client C 120 includes a client application 126.

The control center 104 provides various cloud applications 106 to the client devices 116, 118 and 120 via a hub/bridge 114. The control center 104 controls and co-ordinates the client devices A . . . N (elements 116, 118 and 120) via the cloud arrangement. This “cloud” arrangement allows the client devices 116, 118 and 120 to be small with only the necessary functional structures to perform an assigned task. The control center 104 includes a web server 134 that communicates with a wireless device 132 via the Internet 112. In an embodiment, the web server 134 provides an interface to the wireless device to configure the hub/bridge 114 and each of the client devices A . . . N (elements 116, 118 and 120). The control center 104 also includes a memory 138 for receipt of third party data from third party service providers 140. The control center communicates with the third party service providers 140 via the Internet 112. Such third-party service providers have records concerning the utilization of their service by any particular user. That utilization information can then be provided to the control center for further notification to a user. Such notification can be in text or graphic form in order to encourage a user to utilize the service on a more frequent basis if desired.

The hub/bridge 114 is a device located in proximity to the client devices A . . . N (elements 116, 118 and 120). The hub/bridge 114 connects to the Internet via an interface, such as for example and as a limitation, home broadband router, a cable modem, a DSL modem or a fiber to the home interface. The hub/bridge 114 connects to the client devices via a wireless connection, such as by way of example and by way of limitation, a Zigbee network.

A client, such as the client devices A . . . N (elements 116, 118 and 120) are “smart” devices that interact with the cloud applications 106 via the hub/bridge 114. By way of illustration and not by way of limitation, may be:
a printer
a photo frame that show photos from Facebook
toys that communicate with one another
a landline call alert that provides a text to a user (subscription based)
an MP3 player that acquires a sample MP3 per day and includes a button to buy in iTunes
a digital clock radio with news headlines
a TV/radio that shares listening with friends
a calling device having a single button for requesting a cab
a houseplant water monitor that calls selected numbers
a mini handheld game that facilitates competition on Facebook
an email device that receives the latest emails as an overlay to paste on a window
a designer table lamp projecting photos or the weather
a battery powered watch that only connects to a network when at home and stores birthday of friends
a pedometer that collects information out of the home, and connects to network only at home, wirelessly syncing data

The cloud applications provide data (or commands) to a client device that are appropriate to the functions assigned to the client device. For example, a printer would receive a file for printing, a radio would receive audio for streaming, and a clock would receive a current time for a particular location. These data or commands can be in a form to notify a user that he service has not been used over a period of time and to encourage a user to make further use of such a service.

The interactions between the client devices (elements 116, 118 and 120), the hub/bridge 114 and the control center 104 may be performed in different ways. In one embodiment, a client, such as the client A 116, utilizes a client application, such as client application 122, to regularly poll the hub/bridge 114 to determine if a new payload (or a command) is available for retrieval. The polling also announces the presence and status of the client A 116 to the hub/bridge 114. The hub/bridge 114 then polls the control center 104 using API 108 to determine if there any payloads waiting for the client devices connected to the hub/bridge 114, such as client devices A . . . N (elements 116, 118 and 120). In another embodiment, the hub/bridge 114 may poll the control center 104 for payloads addressed to the client devices connected to the hub/bridge 114, such as client devices A . . . N (elements 116, 118 and 120). The hub/bridge 114 may then deliver the payloads to the appropriate client when polled by that client.

In another embodiment, the hub/bridge 114 polls the control center 104 for payloads and commands for client devices (elements 116, 118 and 120) that are known to the hub/bridge 114. However, the client devices (elements 116, 118 and 120) do not poll the hub/bridge 114. Rather, the hub/bridge 114 pushes the payloads to its known client device.

In another embodiment, the applications that provide services to client devices are located in a cloud storage system 106 that is accessible via a network to the hub/bridge 114. In this embodiment, cloud applications 106 cloud provide commands and messages that are pushed to hub/bridge over a stateful network connection. For example, a websocket or similar protocol may be used to provide a bi-directional, full-duplex communications channel over a single TCP connection over which an application server may send content to a client device without first being solicited by the client. In this way, commands and payloads may be passed to the hub/bridge 114 while the connection between the hub/bridge 114 and the cloud is open.

In another embodiment, the hub/bridge 114 polls the control center 104 for payloads and commands for client devices (elements 116, 118 and 120) that are known to the hub/bridge 114. However, the client devices (elements 116, 118 and 120) do not poll the hub/bridge 114. Rather, the hub/bridge 114 pushes the payloads to its known client devices. In an embodiment, the hub/bridge 114 becomes aware of a client device connected to it by virtue of “heartbeat” signals that are sent by client devices to the hub/bridge 114. There is no status data encoded in the heartbeat event. Rather, the hub/bridge uses the presence of these heartbeats to determine whether or not it should retrieve commands from the cloud for that device.

The commands and messages for the hub/bridge 114 may be stored in a message queue according to a priority established by the control center 104.

Commands to client devices may fail in a temporary manner, in which case they are retried by the cloud, or may fail permanently, in which case they are not retried. This temporary or permanent condition is encoded in the command response code from the client device to which the command is directed. The command response code received from the client device facilitates that monitoring of the status and usage of client devices. These data may be used to identify and correct problems with client devices as, for example, a printer that is out of paper or a device family that suffers from a common bug.

The architecture illustrated in FIG. 1 provides a number of advantages. Both the complexity of the hub/bridge 114 and the client devices A . . . N (elements 116, 118 and 120) are substantially reduced. As a result, the cost of hardware required to perform the functions of system 100 are reduced. Additionally, the need for firmware upgrades and the additional development time of software for the hub/bridge and client devices is minimized or avoided entirely. Rather, all third party API requests and any long processing jobs are done at the control server 104.

In an embodiment, the client devices are designed for a low data rate network, such as Zigbee. In this embodiment, the memory allocated to client devices may be limited.

In another embodiment, the transport layer of the client devices and the hub/bridge does not support user permissions or user access controls. This means that any client is allowed to join any hub/bridge. The client is, however, is not generic. That is, its API is entirely function specific.

The hub/bridge 114 is a regarded as untrusted. It is not capable of decrypting message payloads. Additionally, the hub/bridge 114 is client agnostic. It does not treat messages differently dependent on client class or Message type. A client is conceptually an object instance which “knows” how to accept a number of different message types and is capable of generating a set of messages types.

Further, a hub/bridge is allowed to register the presence of any client so long as the client is physically present. Ownership is managed entirely by the control center 104 using the cloud applications 106. Permissions are managed at the “presentation layer” inside messages. So long as message payload is secure between the client devices A . . . N (elements 116, 118 and 120) and the control center 104, permissions and ownership can be managed at the control center 104. By controlling securing between devices and the control center, the security of payloads may be protected even if a device is connected to an untrusted hub/bridge.

In an embodiment, to maintain security, a common shared secret method is used. Each client generates a seed used to generate a cryptographic key. The algorithm used by the client to generate the seed is shared with the control center 104. The seed is shared with the control center 104 using an out-of-band method bypassing the hub/bridge 114, thus a common shared secret is established. A client may be capable of generating a new seed on demand. Message payloads between the control center 104 and client via the hub/bridge 114 are therefore secure. According to an embodiment, the control center 104 operates as a mailbox for all client devices. Messages may be linked to form a client's message queue when they are ready to be downloaded. Although the messages that appear in a client's inbox are client-specific, the conceptual model of a client inbox is generic across all possible client types. The hub/birdge 114 regularly polls the control center 104, and downloads messages on behalf of connected, local client devices (it also uploads messages and client statuses). The routing information is used to direct messages.

The control center 104 component is also where connections to third party web services are made. By way of illustration and not by way of limitation, a client may be assigned the function of printing content from Facebook. In this example, the control center 104 is responsible for interfacing with the Facebook web services, transforming the data, and emitting messages to the printer/client in the form of content to be printed. Neither the hub/birdge 114 nor any client is capable of contacting a third party web service directly.

In an embodiment, a hub/birdge 114 is identified to the control center 104 by an identifier, such as a hash of a hardware identification code. The hub/bridge identifier never changes.

In an embodiment, a client, such as one of client devices A . . . N (elements 116, 118 and 120), is identified by a hardware identification code and communicates with the control center 104 using an internally-generated cryptographic key, such as its common shared secret. In an embodiment, a client operates a script that produces the cryptographic key. In another embodiment, this script is maintained in a secure memory, processor or ASIC chip. The script may be controlled by the control center 104 to produce a new cryptographic key and to present the user with a claim code to pass to the control center 104 via an out-of-band process in order that the control center 104 may generate the same new cryptographic key, thus creating a common shared secret.

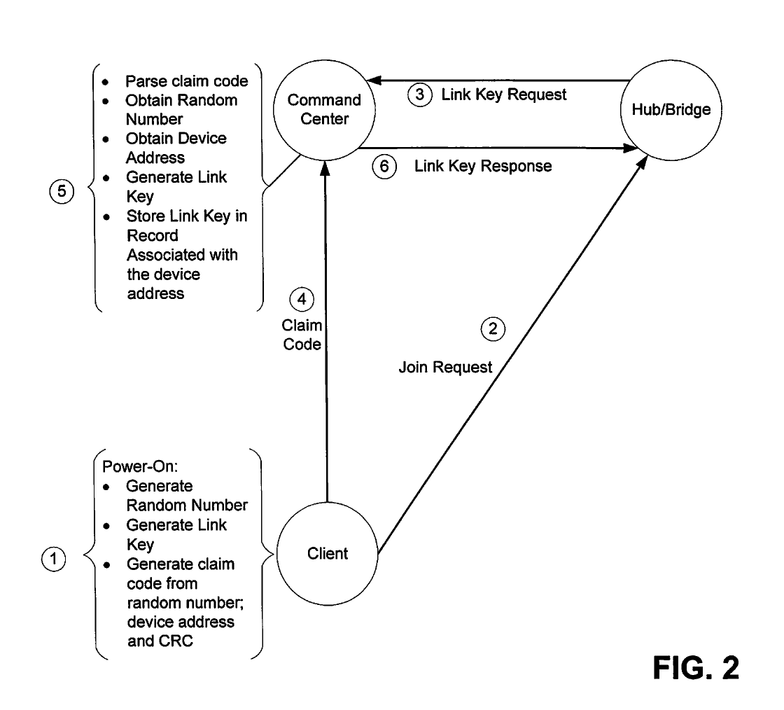

FIG. 2 is a flow diagram illustrating an authentication process according to an embodiment.

When a client device is first powered on, the client device generates a random number which is in turn used to generate a link key and the random number is encoded into a client claim code along with the client address and CRC. (Circle 1.)

When the client device attempts to join a hub/birdge 114 (Circle 2), the hub/birdge 114 responds with a request to control center 104 for the link key for the client (Circle 3). The request for the link key (Circle 3) is received by a control center 104. Contemporaneously with sending of the join request (Circle 3), the client device provides the claim code to the control center 104 without the claim code passing through the hub/birdge 114. (Circle 4.) For example, the claim code may be provided by the user to a website accessible to the control center 104. The claim code is processed by the control center 104 to obtain the client device address and the random number used to generate the link key. (Circle 5.) The control center then uses the same algorithm to generate the link key from random number. The client device address is used to locate a record associated with the client device and to store the link key generated by the control center 104.

The control center 104 responds to the request from the hub/birdge 114 with the link key generated by the control center and stored in the record associated with the client device. (Circle 6). At this point in the process, there are two link keys: one in the client device and used to generate the claim code, and the other held by the hub/birdge 114 generated by the control center 104 using the user-entered claim code. The two link keys will be identical if the claim code has been provided correctly to the control center 104. Using symmetric cryptography, secure communication between the client device and the hub/birdge 114 will only occur if both keys are the same. The client device issues a power-on event (described below) to initiate communications between the client device and the control center 104 via the hub/birdge 114.

In an embodiment, payloads are delivered in “packages.” To illustrate the use of packages, the description that follows describes an implementation of a JavaScript Object Notation (JSON) package object. However, this is not meant as a limitation. Other package structures may be used to convey the payload and metadata that is exchanged by the system components.

JSON utilizes a collection of name/value pairs (sometimes referred to herein as a “dictionary”) and an ordered list of values.

In this embodiment, payloads are contained in packages which are JSON objects containing the payload and other metadata for use by the hub/birdge 114. The metadata is used by the hub/birdge 114 to send the package to the correct client A . . . N (elements 116, 118 and 120). There may be some duplication between a payload and a package to allow both the hub/birdge 114 and the client devices A . . . N (elements 116, 118 and 120) to read the payload.

In an embodiment, a package object dictionary contains:
type: Required. Indicates whether the command is intended for the hub/bridge or an end device.
device_address: Optional. The destination address for this command. Must either be a device_address or bridge_address key.
bridge_address: Optional. See above.
binary_payload: Optional. Payloads are either encoded binary data, or represented as JSON. This contains the actual command itself.
json_payload: Optional. See above.
timestamp: Optional. Encodes the time at which the command was created.

An example of a package object is set forth below:

{‘type’: ‘BridgeCommand’, ‘bridge_address’: ‘0011223344aabb00’, ‘json_payload’: {‘name’: ‘add_device_encryption_key’, ‘params’: {‘device_address’=>‘0011223344aabb01’, ‘encryption_key’=>‘SGVsbG9Gcm9tQkVSRyE=\n’}}, ‘timestamp’: 1334852151.000000}

In an embodiment, a payload contained in a package is represented by base 64 encoded strings. By way of illustration and not by way of limitation, a device command payload may use the following message structure:
Device type, 8-bit unsigned integer
Reserved, 8-bits, 0 padded
Command type ID, 16-bit unsigned integer, the number of the command as specified above
CRC32, 32-bit, optionally all zero
Command payload length, 32-bit unsigned integer. The number of bytes of rest of command. Not inclusive of first three integers
Command payload data, variable, depends on command type ID, etc.

From the perspective of the hub/birdge 114, a device command has the following message structure:

{
′type′: ′DeviceCommand′,
′device_address′: ′0011223344aabb01′,
′binary_payload′: ″SGVsbG9Gcm9tQkVSRyE=\n″,
′timestamp′: 1334852161.000000
}

Once unencoded, the strings are binary data representing a packed C structure (or “struct”). Each command has a separate definition for this struct, but always begins with:
an 8-bit unsigned integer (unsigned char) identifying the client type.
an 8-bit unsigned integer (unsigned char) identifying the spec version of the client type.
an 8-bit unsigned integer (unsigned char) which is the command ID for the command as specified for that client class.

In an embodiment, the definitions for all payload C structs are incorporated into the cloud application 106 and the client application 122. As indicated previously, commands are sent from the control center 104 to the client devices A . . . N (elements 116, 118 and 120) via the hub/birdge 114.

The following is an example of a request in the form of a c-URL script sent from a hub/bridge with one client connected to it:
curl -H “Content-Type: application/j son”-i-X POST-d “{‘bridge address’:
‘0011223344aabb00’, ‘device_addresses’: [0011223344aabb01′]}” https://bridge-api.bergcloud.com/api/v// 1/commands

In response to a request, the control center 104 may respond with a URL indicating that a payload is ready for the device identified in the request message. An example response for the above request is there is one packaged payload ready for download for the one client connected:
{“0011223344aabb01”:“https://hub/bridge-api.bergcloud.com/api/v1/commands/1”}

The hub/birdge 114 may then issue a c-URL request to obtain the payload: curl -H “Content-Type: application/json” -i -X POST -d “{‘bridge address’: ‘0011223344aabb00’, ‘device_addresses’: [0011223344aabb011}” https://bridge-api.bergcloud.com/api/v1/commands/1

In response, the control center 104 provides a packaged payload in a JSON object:

{
′type′: ′DeviceCommand′,
′device_address′: ′0011223344aabb01′,
′binary_payload′: ″SGVsbG9Gcm9tQkVSRyE=\n″,
′timestamp': 1334852161.000000
}

The response URL is the command URL plus “/response” added to the end, or in this example: https://bridge-api.bergcloud.com/api/v1/commands/1/response. The encoded payload data may include:

{
′type′: ′DeviceCommandResponse′,
′bridge_address′: ′0011223344aabb00′,
′device_address′: ′0011223344aabb01′,
′command_id′: 2,
′return_code′: 1,
′timestamp′: 1334831441.000000
}

Events are sent from the client devices A . . . N (elements 116, 118 and 120) to the control center 104 also via the hub/birdge 114. Event payloads are very similar to command payloads, differentiated by the direction they are travelling (client to hub/bridge to control center). In an embodiment, an event payload may use the following message structure:
Event Code, 16 bit integer
Command Invocation ID, 32 bit integer, Reserved: 0, used if the event is related to a command
Event Payload Length, 32 bit
Event Payload Data, variable

Events are posted to https://bridge-api.bergcloud.com/api/v1/events. From the perspective of the hub/birdge 114, event commands may appear as follows:

{
′type′: ′DeviceEvent′,
′bridge_address′: ′0011223344aabb00′,
′device_address′: ′0011223344aabb01′,
′binary_payload′: ″SGVsbG9Gcm9tQkVSRyE=\n″,
′timestamp′: 1334831421.000000
}

By way of illustration and not by way of limitation, a power-on event may be reported using the following message structure:
Event Code, 16 bit integer
Command Invocation ID, 32 bit integer, Reserved: 0, used if the event is related to a command
Event Payload Length, 32 bit
Event Payload Data, variable

The power-on event thus encodes both the device type, the firmware version and the protocol version, all of which allow the construction of the correct payloads destined for the device.

In an embodiment, errors are reported by posting a return code key to the /response URL for the command. For example, if for some reason a host fails to contact a device, or an exception is raised during the processing of at command, a return code of 255 is returned to the /response URL. In an embodiment, logging statements are generated and sent to the control center 104, with details of the location and line number where the exception was generated, and posted to the events URL as the following:

{
′type′: ′BridgeLog′,
′bridge_address′: ′0011223344aabb00′,
′records′: [ .. array of log record hashes .. ]
}

According to an embodiment, log records may contain the following keys:
‘name’
‘message’
‘levelname’
‘levelno’
‘created’
‘process’
‘processName’

A user can also elicit personalized editorial content to be printed and displayed. For example events from social networks and various social feeds may be printed. Other types of personal content may also be printed such as personalized advertisements, coupons, and other commercial listings of interest to a user. Personal geo-located information may also be a subject of a subscription. For example geo-located information may include information concerning a user's location, the location of friends, places visited and other geo-located events. Further, personal utility information such as appointments, document updates, items being tracked by a user, financial information concerning a user's stocks (etc.) may all be the subject of immediate printing.

Embodiments herein may also include iconic representations of information related to the state of a client device, the use of a service and data being received. For example, a client device that performs as a printer may include an active display element that displays an iconic representation, such as a face, indicating certain aspects of the content of the messages being printed. In the case of a client device functioning as a printer, the iconic representation may be imprinted on the content that is printed for the user. For example, an image that depicts a happy face may be associated with personalized alerts concerning friends and events. Alternatively, the happy face may indicate that the user uses a particular service on a frequent basis. In the event that a service has not been used over a certain period of time, a sad face may be displayed and printed to the user effectively reminding the user that the service is present but has not been used particularly often.

Iconic representations may be displayed on client devices such as a music player, an email receiver, and a weather station. The iconic representations may reflect the nature of the content (happy music or sad music, an email from a family member or an email from a vendor; and warm weather, cold weather, windy weather, or wet weather). The iconic representation may also be chosen to relate the state of the device or the frequency of use of a particular service.

The iconic representations are generated by the control center 104 and pushed to the client. A user may elect not to receive icons for a particular client and may choose the appearance of the icon for particular client devices. For example, a client that operates as a printer may utilize an icon that has facial features selected and customized by a user to depict a face that has glasses, facial hair, hairstyles of various types, and so on. In an embodiment, that facial representation may at least in part be indicative of the status of the printer and potentially the information that is about to be printed. For example, in an embodiment, the current face illustrated on the printer may be indicative of the printer state itself. For example, if the printer is not capable of printing due to error, paper supply, or some other factor, the face that is displayed may be “sad” indicating the printer condition.

In another embodiment, the face that is illustrated on the printer may be indicative of the type of information that is about to be printed. Again, by way of illustration and not by way of limitation, the printer may display a happy face when the content of the information that is being served to the printer relates to somewhat more upbeat information such as information about friends, events, etc. Information that is of a financial nature may cause a serious face to be displayed on the printer indicating the type of information that is about to be displayed.

Other types of faces or images may be uniquely associated with particular conditions or the types of news or feeds to which the user subscribes. These faces may be customized by the user so that a personalized experience may be created by the user and may allow that particular user to have immediate recognition concerning the information that is about to be received.

In an embodiment, the iconic representations for a particular client device may change according to usage. A neutral representation may be selected to indicate that the “normal” state of the client device. Usage of the device may cause the iconic representation to change to a positive representation indicating that the client device is “happy.” For example a printer may receive a message to print or a music player may loaded with a new song. The iconic representation may return to the “normal state” at a fixed time following after the event that triggered the change from neutral to happy.

When a device is not used for a period of time (or the device has become inoperative), the icon representation may change from neutral to an iconic representation that is indicative of an “unhappy” state. The iconic representation may return to the “normal state” following usage of the client device or the correction of the error.

In an embodiment, multiple iconic representations may be used to indicate degrees of “happiness” or “unhappiness.” The movement from one level of happiness or unhappiness may be time based.

By virtue of the network connections of the various embodiments, updates of the printer face result in similar updates on a user's mobile device. In this instance, if a user subscribes to search feeds and the user has established a particular face associated with a particular data feed, whenever information is being printed, the face associated with that information is also sent to a user's mobile device with the appropriate messaging.

Other various facial conditions and customizations may be accomplished by the user and are illustrated in attachments hereto. Further, the system comprises its own ability to change the various polices selected by the user to reflect inactivity of the system or system problems to which the user should be alerted.

Thus with respect to printing, while the user has abilities to customize the faces to be displayed, and the various content that is to be displayed in association with a variety of customized faces, the control center supplies not only the information to be displayed but the appropriate modifications to the faces to be displayed along with the information.

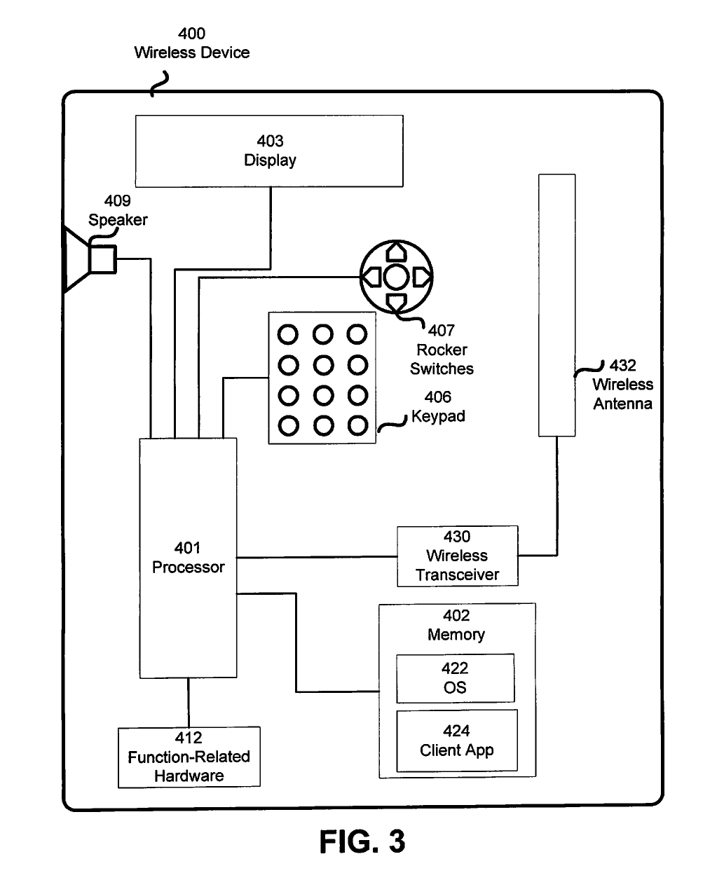

A typical client device suitable for use with certain embodiments may have in common the components illustrated in FIG. 3. For example, the exemplary client device 400 may include a processor 401 coupled to an internal memory 402 and to a display 403. A client device typically also includes a key pad 406 or miniature keyboard and menu selection buttons or rocker switches 407 for receiving user inputs. A wireless transceiver 430 may be coupled to the processor 401 and an antenna 432 for communicating wireles sly with another device such as hub/birdge 114. By way of illustration and not by way of limitation, the wireless transceiver may be compliant with Zigbee standards.

Function-related device 412 may also be coupled to the processor 401. For example, if the client device is intended to operate as a printer, the function-related device would be a print engine as known in the art.

The processor 401 may be any programmable microprocessor, microcomputer or multiple processor chip or chips that can be configured by software instructions (applications) to perform a variety of functions, including the functions of the various embodiments described herein. In some client devices, multiple processors 401 may be provided, such as one processor dedicated to wireless communication functions and one processor dedicated to running other applications. Typically, software applications may be stored in the internal memory 402 before they are accessed and loaded into the processor 401. In some client devices, the processor 401 may include internal memory sufficient to store the application software instructions. As part of the processor, such a secure memory may not be replaced or accessed without damaging or replacing the processor. In many client devices, the internal memory 402 may be a volatile or nonvolatile memory, such as flash memory, or a mixture of both. For the purposes of this description, a general reference to memory refers to all memory accessible by the processor 401, including internal memory 402, removable memory plugged into the client device, and memory within the processor 401 itself, including the secure memory.

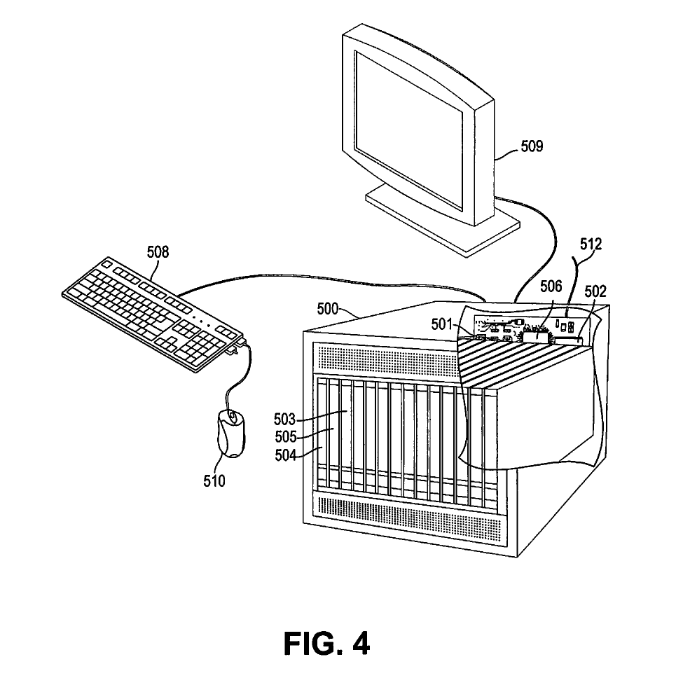

A number of the embodiments described above may also be implemented on any of a variety of commercially available server devices, such as the server 500 illustrated in FIG. 4. Such a server 500 typically includes a processor 501 coupled to volatile memory 502 and a large capacity nonvolatile memory, such as a disk drive 503. The server 500 may also include a floppy disc drive, compact disc (CD) or DVD disc drive 504 coupled to the processor 501. The server 500 may also include network access ports 506 coupled to the processor 501 for establishing data connections with a network 512, such as the Internet. Servers 500 may also include operator interfaces, such as a keyboard 508, pointer device (e.g., a computer mouse 510), and a display 509.

The processor 501 may be any programmable microprocessor, microcomputer or multiple processor chip or chips that can be configured by software instructions (applications) to perform a variety of functions, including the functions of the various embodiments described below. For example, the software instructions may include the API 208, the cloud applications 206 and the web server 134 functions illustrated in FIG. 1 Multiple processors may be provided, such as one processor dedicated to wireless communication functions and one processor dedicated to running other applications. Typically, software applications may be stored in the internal memory 502, 503 before they are accessed and loaded into the processor 501. The processor 501 may include internal memory sufficient to store the application software instructions.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of client devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module, which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A system for providing functionality to a client device via a network, wherein the system comprises:
a client device;
a control center, wherein the control center comprises an application receiving first payload data from the client device and sending second payload data to the client device; and
a bridge device in communication with the control center and the client device, wherein the client sends the first payload data to the control center via the bridge device and receives the second data payload from control center via the bridge device.

2. The system of claim 1, wherein the application is a monitoring application and wherein the second payload comprises an iconic representation of at least one measure of the status of the client device as determined by the monitoring application.

3. The system of claim 2, wherein the client device comprises a display and wherein in response to the receipt of the payload, the client device displays the iconic representation of the at least one measure on the display.

4. The system of claim 2, wherein the client device comprises a printing component and wherein in response to the receipt of the payload, the client device prints the iconic representation of the at least one measure using the printing component.

5. The system of claim 2, wherein the at least one measure is selected from a frequency of usage of a client device, a time since a last usage of a client device, a failure of the client device to receive the second payload, and an error reported by the client device to the control center in a first payload.

6. The system of claim 2, wherein the at least one measure of the status of the client device is assigned a value relative to a threshold value and wherein the iconic representation is selected to provide a qualitative indication of the assigned value.

7. The system of claim 6, wherein assigned value is below the threshold value and the selected iconic representation comprises a graphic of an unhappy face.

8. The system of claim 7, wherein assigned value is above the threshold value and the selected iconic representation comprises a graphic of a happy face.

9. The system of claim 1, wherein the application is an event application and wherein the second payload comprises an iconic representation of an event as determined by the event application.

10. The system of claim 9, wherein the event application comprises a weather forecasting application and wherein the iconic representation of the event comprises an iconic representation of a weather event.

11. A method for providing functionality to a client device via a network, the method comprising:
receiving first payload data at a control center from a client device via a bridge device; and
sending a second payload data to the client device from the control center via the bridge device.

12. The method of claim 11, wherein the second payload comprises an iconic representation of at least one measure of a status of the client device as determined by a monitoring application.

13. The method of claim 12, wherein the client device comprises a display and wherein the method further comprises:
displaying by the client device the iconic representation of the at least one measure on the display in response to the receipt of the payload.

14. The method of claim 12, wherein the client device comprises a printing component and wherein the method further comprises:
printing by the client device the iconic representation of the at least one measure using the printing component in response to the receipt of the payload.

15. The method of claim 12, wherein the at least one measure is selected from a frequency of usage of a client device, a time since a last usage of a client device, a failure of the client device to receive the second payload, and an error reported by the client device to the control center in a first payload.

16. The method of claim 12, wherein the at least one measure of the status of the client device is assigned a value relative to a threshold value and wherein the method further comprises:
selecting the iconic representation to provide a qualitative indication of the assigned value.

17. The method of claim 16, wherein assigned value is below the threshold value and the selected iconic representation comprises a graphic of an unhappy face.

18. The method of claim 17, wherein assigned value is above the threshold value and the selected iconic representation comprises a graphic of a happy face.

19. The method of claim 11, wherein the second payload comprises an iconic representation of an event as determined by an event application.

20. The method of claim 19, wherein the event application comprises a weather forecasting application and wherein the iconic representation of the event comprises an iconic representation of a weather event.
